(19) United States
(12) Patent Application Publication
(10) Pub. No.: US 2015/0139074 A1
(43) Pub. Date: May 21, 2015

(54) Adaptive Generation of Network Scores From Crowdsourced Data

(71) Applicants: Ryan H. Bane, Redmond, WA (US); Adam R. Dyba, Redmond, WA (US); Aurelio Navarro Belletti Garcia, Issaquah, WA (US); James Christopher Gray, Redmond, WA (US); Shai Guday, Redmond, WA (US); Tyler E. Hennessy, Woodinville, WA (US); Ayman Kaheel, Bellevue, WA (US); Shobana Kapoor, Woodinville, WA (US); Triptpal Singh Lamba, Bothell, WA (US); Darya Mazandarany, Kirkland, WA (US); Michael Hao Mi, Redmond, WA (US); Christopher R. Rice, Redmond, WA (US); Tomasz W. Rogozik, Seattle, WA (US); Peter Schmatz, Sammamish, WA (US); Michael Svanholm Thomsen, Redmond, WA (US); Robert C. Villahermosa, Redmond, WA (US)

(72) Inventors: Ryan H. Bane, Redmond, WA (US); Adam R. Dyba, Redmond, WA (US); Aurelio Navarro Belletti Garcia, Issaquah, WA (US); James Christopher Gray, Redmond, WA (US); Shai Guday, Redmond, WA (US); Tyler E. Hennessy, Woodinville, WA (US); Ayman Kaheel, Bellevue, WA (US); Shobana Kapoor, Woodinville, WA (US); Triptpal Singh Lamba, Bothell, WA (US); Darya Mazandarany, Kirkland, WA (US); Michael Hao Mi, Redmond, WA (US); Christopher R. Rice, Redmond, WA (US); Tomasz W. Rogozik, Seattle, WA (US); Peter Schmatz, Sammamish, WA (US); Michael Svanholm Thomsen, Redmond, WA (US); Robert C. Villahermosa, Redmond, WA (US)

(21) Appl. No.: 14/081,199

(22) Filed: Nov. 15, 2013

(51) Int. Cl. H04W 48/08; H04L 29/06

(52) U.S. Cl. CPC H04W 48/08; H04L 65/00
USPC 370/328

(57) ABSTRACT

Embodiments generate and provide connection quality data for networks based on past performance of those networks. Network experience data and corresponding device context are received from a first set of mobile devices. The received data is processed to generate the connection quality data, which is distributed to a second set of mobile devices for use in selecting a network and establishing a connection. Feedback describing performance of the selected network is received and applied to adjust the previously generated connection quality data. In some embodiments, the connection quality data represents voice over Internet Protocol (VoIP) call quality.

### BACKGROUND

With the increased popularity of smart telephones, tablets, and other mobile devices, there has been an increase in the quantity of networks available to these mobile devices. However, different networks often provide different levels of service and performance, such as bandwidth, security, and latency. Further, different networks have different reliability. Some existing systems are not capable of rating the networks based on performance, let alone adjusting those ratings in real-time based on feedback from mobile devices connecting to those networks.

For example, voice over Internet Protocol (VoIP) calls have become a viable alternative to circuit switched calls (e.g., over cellular networks) on the mobile devices. At least because of the variable quality of wireless fidelity (Wi-Fi) and cellular data networks, some networks provide better performance for VoIP calls than other networks. However, with some of the existing systems, mobile devices are unable to identify the networks with higher performance before the call is placed.

### SUMMARY

Embodiments of the disclosure crowdsource data from a plurality of mobile computing devices to form connection quality data for distribution. Network experience data and corresponding device context is received from a first set of mobile computing devices. The network experience data describes performance of at least one of a plurality of networks as observed by the mobile computing devices in the first set. The received network experience data and corresponding device context is processed to generate the connection quality data for one or more of the networks. The generated connection quality data is distributed to a second set of mobile computing devices and/or distributed back to the first set of mobile devices as aggregated quality data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a cloud service receiving data from mobile computing devices that connect to networks.

FIG. 2 is an exemplary block diagram illustrating a computing device of the cloud service storing connection quality data derived from network experience data and corresponding device context.

FIG. 3 is an exemplary flow chart illustrating operation of the cloud service to generate and distribute connection quality data from crowdsourced data.

FIG. 4 is an exemplary flow chart illustrating operation of the cloud service to update connection quality data based on network usage feedback received from mobile computing devices.

FIG. 5 is an exemplary block diagram illustrating structure and organization of the cloud service.

FIG. 6 is an exemplary block diagram illustrating structure and organization of front-end modules of the cloud service.

FIG. 7 is an exemplary block diagram illustrating structure and organization of an offline learning system of the cloud service.

FIG. 8 is an exemplary sequence diagram illustrating interaction among the mobile computing devices and modules of the cloud service.

Corresponding reference characters indicate corresponding parts throughout the drawings.

### DETAILED DESCRIPTION

Referring to the figures, embodiments of the disclosure crowdsource data describing past performance of networks 108 to predict future performance. In some embodiments, the past performance is represented by network experience data 210 and corresponding device context 212. The crowdsourced data is integrated, analyzed, or otherwise processed to produce connection quality data 214. The connection quality data 214 includes, in some examples, quality scores for each of the networks 108. The connection quality data 214 is made available to mobile computing devices 102 that then apply the connection quality data 214 to select networks 108 for connection.

Some embodiments collect the network experience data 210 specific to voice over Internet Protocol (VoIP) calls. Machine-learning techniques are applied to the collected network experience data 210 to produce models that predict VoIP performance for any given network 108. While such an embodiment describes VoIP call quality, aspects of the disclosure are applicable to any kind of network 108, including but not limited to wireless fidelity (Wi-Fi), cellular, satellite, and whitespace.

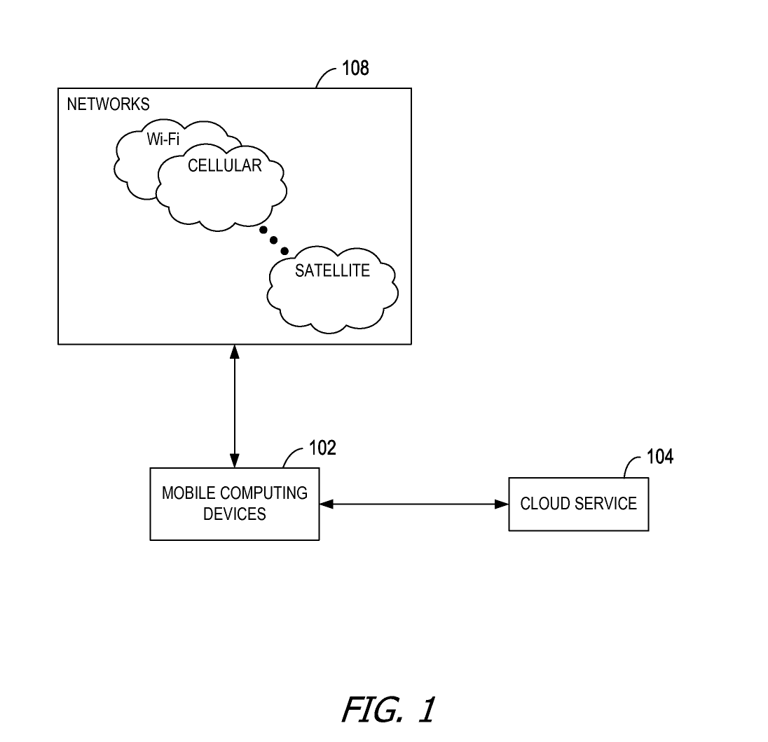

Referring next to FIG. 1, an exemplary block diagram illustrates a cloud service 104 receiving data from the mobile computing devices 102 that connect to networks 108, such as Wi-Fi, cellular, and satellite. In the example of FIG. 1, a user interacts with the mobile computing device 102, or any other computing device of the user. The mobile computing device 102 executes one or more applications to perform functionality. Exemplary applications include mail application programs, web browsers, calendar application programs, address book application programs, messaging programs, media applications, location-based services, search programs, and the like. During execution, the applications may attempt to communicate with other devices across one or more of the networks 108. Communication between the mobile computing device 102 and other devices may occur using any protocol or mechanism over any wired or wireless connection. For example, the applications may attempt to transmit and/or receive data over a Wi-Fi network, a cellular network, a satellite network, a whitespace network, or any other network 108. In some embodiments, the applications represent downloaded client-side applications that correspond to server-side web services.

As described further herein, the cloud service 104 collects information from the mobile computing devices 102 related to the performance of the networks 108, as observed by the mobile computing devices 102. The cloud service 104 then generates models for predicting future performance of the networks 108 for use by the mobile computing devices 102.

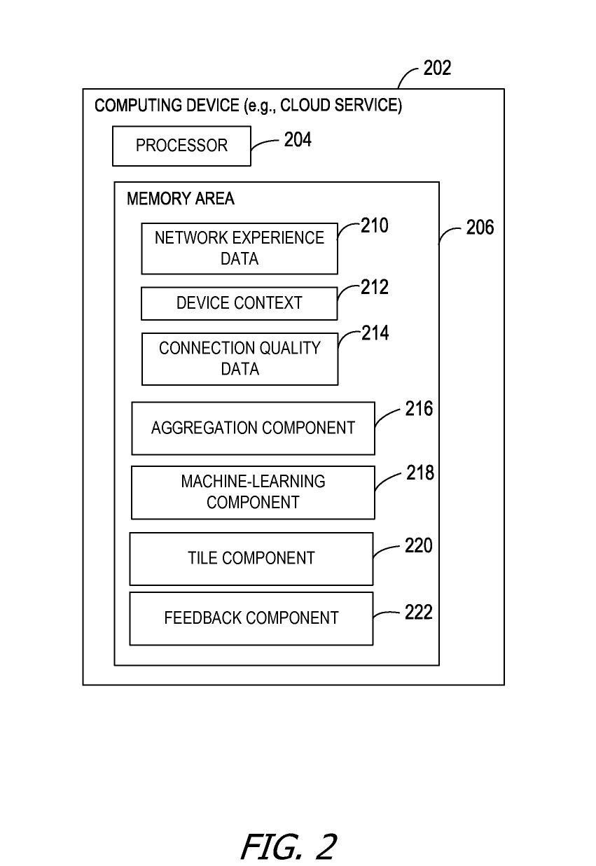

Referring next to FIG. 2, an exemplary block diagram illustrates a computing device 202 of the cloud service 104 storing connection quality data 214 derived from network experience data 210 and corresponding device context 212. In the example of FIG. 2, the computing device 202 associated with the cloud service 104 implements a system for crowdsourcing data from the mobile computing devices 102 to form connection quality data 214 for distribution. The computing device 202 represents any device executing instructions (e.g., as application programs, operating system functionality, or both) to implement the operations and functionality associated with the cloud service 104. The computing device 202 may also represent a group of processing units or other computing devices. In another example, the computing device 202 may include a mobile computing device or any other portable device, such as a mobile telephone, laptop, tablet, computing pad, netbook, gaming device, and/or portable media player. Alternatively or in addition, the computing device 202 may include less portable devices such as desktop personal computers, kiosks, tabletop devices, industrial control devices, wireless charging stations, and electric automobile charging stations.

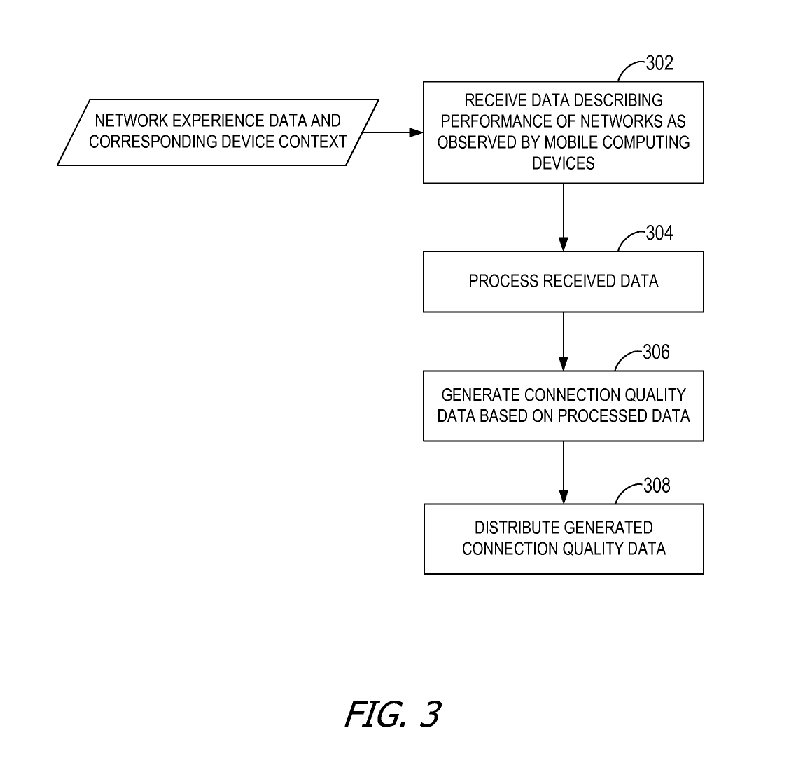

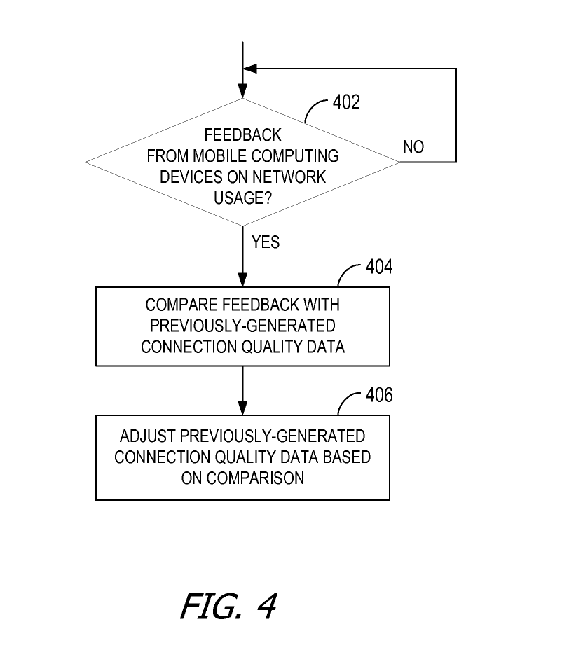

In some embodiments, the computing device 202 has at least one processor 204 and a memory area 206. The computing device 202 may further have one or more communications interfaces (not shown) including at least one network interface card and/or computer-executable instructions (e.g., a driver) for operating the network interface card. The processor 204 includes any quantity of processing units, and is programmed to execute computer-executable instructions for implementing aspects of the disclosure. The instructions may be performed by the processor 204 or by multiple processors executing within the computing device 202, or performed by a processor external to the computing device 202. In some embodiments, the processor 204 is programmed to execute instructions such as those illustrated in the figures (e.g., FIG. 3 and FIG. 4).

In some embodiments, the processor 204 represents an implementation of analog techniques to perform the operations described herein. For example, the operations may be performed by an analog computing device and/or a digital computing device.

The computing device 202 further has one or more computer readable media such as the memory area 206. The memory area 206 includes any quantity of media associated with or accessible by the computing device 202. The memory area 206 may be internal to the computing device 202 (as shown in FIG. 2), external to the computing device 202 (not shown), or both (not shown). In some embodiments, the memory area 206 includes read-only memory and/or memory wired into an analog computing device.

The memory area 206 further stores network experience data 210. The network experience data 210 describes performance of at least one of the networks 108 as observed by one or more of the mobile computing devices 102 over time. As an example, the network experience data 210 describes the call quality of VoIP calls placed over the networks 108. Other exemplary network experience data 210 includes values for one of more of the following measurements, observations, characteristics, and/or properties: network throughput, signal quality, jitter, and/or packet loss, and/or a user evaluation or rating. For example, packet loss may be represented by a packet loss rate. Further, the latency and/or jitter may be represented by maximum and average values. For mobile computing devices 102 capable of VoIP, the network experience data 210 may also include one or more of the following: a start time for a VoIP call, an end time for a VoIP call, a duration of a VoIP call, and whether the call terminated successfully.

The memory area 206 further stores device context 212 corresponding to the network experience data 210. In some embodiments, the device context 212 describes the current (or recent) operating conditions and/or parameters of the mobile computing devices 102 when the mobile computing devices 102 collected or generated the network experience data 210. For example, the device context 212 represents measurements of signals available to the mobile computing device 102, a description of the hardware of the mobile computing device 102, and/or a description of the software of the mobile computing device 102. In some embodiments, the device context 212 includes, but is not limited to, time, date, a battery level, signal strengths for the networks 108, network types for the networks 108, network speeds, a location of the mobile computing device 102 (e.g., when the data transmission started and ended), a user identifier, a user profile, device conditions, whether the user connected automatically or manually to the network 108, user preferences, user dwell time on the networks 108, a usage scenario, application identifiers of the executing and/or installed applications, device movement (e.g., from an accelerometer, gyroscope, and/or a global positioning system), weather local to the mobile computing device 102, device type, device make, device model, operating system type and build, data transmission costs, and/or a remaining network data consumption amount under a data plan. The device context 212 may also include a network type, such as 802.11(a,b,g,n), Enhanced Data for Global Evolution (EDGE), 3G, High-Speed Downlink Packet Access (HSDPA), Long-Term Evolution (LTE), and the like. For cellular networks, the device context 212 may also include one or more of the following: a cellular identifier, mobile country code (MCC), mobile network code (MNC), signal quality of the cellular tower, and/or the air interface. The device context 212 may be represented in any form, such as values, strings, and/or other data types associated with a plurality of characteristics or properties.

The memory area 206 further stores connection quality data 214 for the networks 108. The connection quality data 214 for each of the networks 108 describes the anticipated, expected, and/or predicted experience of the applications executing on the mobile computing devices 102 to transmit and/or receive data over that network 108. As described further herein, the connection quality data 214 is produced, generated, calculated, derived, and/or determined, by the cloud service 104, from the network experience data 210 and corresponding device context 212.

The connection quality data 214 for a particular network 108 may include a score for that network 108. The score represents a value calculated from the crowdsourced network experience data 210 and corresponding device context 212. As an example, the score for a particular network 108 may be calculated as a mean opinion score (MOS) (e.g., to objectively qualify the quality of a voice call made using that particular network 108). In some embodiments, the MOS is limited to consideration of the network properties that affect performance of the network 108 relative to a VoIP call. Aspects of the disclosure are operable, however, with any ground truth label and are not limited to MOS.

The score may be represented as a numerical rating (e.g., zero to five with zero being poor and five being excellent) and/or a star rating (e.g., zero to five stars with zero stars being poor and five stars being excellent).

As another example, the connection quality data 214 may identify minimum, average/median, and/or maximum network characteristics or property values. For example, the connection quality data 214 may identify a minimum data rate, an average latency, and/or a mean signal-to-noise ratio.

The memory area 206 further stores one or more computer-executable components. Exemplary components include an aggregation component 216, a machine-learning component 218, a tile component 220, and a feedback component 222. Operation of these components, when executed, is described below with reference to FIG. 4.

Referring next to FIG. 3, an exemplary flow chart illustrates operation of the cloud service 104 to generate and distribute connection quality data 214 from crowdsourced data. The operations illustrated in FIG. 3 are described with reference to execution by the computing device 202 associated with the cloud service 104. However, aspects of the disclosure contemplate execution of the operations by other devices or processors, such as by one or more of the mobile computing devices 102.

At 302, the computing device 202 receives the network experience data 210 and corresponding device context 212 from a plurality of the mobile computing devices 102. By aggregating the data from each of the mobile computing devices 102, the cloud service 104 is then able to perform mathematical operation on the crowdsourced data. The data may be received in any form of data structure. The data may be received upon demand (e.g., the cloud service 104 requests the data), periodically and/or intermittently (e.g., as part of a daily batch, in response to an event, etc.), and/or as pushed content from the mobile computing devices 102. Exemplary events occurring on the mobile computing devices 102 that prompt the mobile computing devices 102 to collect and send the network experience data 210 and corresponding device context 212 include, but are not limited to, the following examples: connecting to one of the networks 108, disconnecting from one of the networks 108, detecting one of the networks 108 near the mobile computing device 102, placing a VoIP call, and/or ending a VoIP call. For example, upon occurrence of one of the events signaling the start of an activity on the mobile computing device 102, samples are taken and added to a log that is then sent to the cloud service 104 as the part of the device context 212.

Each submission of the network experience data 210 from one of the mobile computing devices 102 describes performance of at least one of the networks 108 as observed by the mobile computing device 102. The computing device 202 may store the received network experience data 210 and corresponding device context 212 in the memory area 206 for processing. In some embodiments, the received data is purged from the memory area 206 after processing. In other embodiments, the received data is purged in accordance with any data retention guidelines associated with the cloud service 104.

At 304, the computing device 202 processes the received network experience data 210 and corresponding device context 212. In some embodiments, the computing device 202 applies one or more machine-learning algorithms to the received data. Exemplary machine-learning algorithms include, but are not limited to, one or more of the following: linear regression, decision tree learning, association rule learning, artificial neural networks, inductive logic programming, support vector machines, clustering, Bayesian, reinforcement learning, representation learning, similarity and metric learning, sparse dictionary learning, and the like. The machine-learning algorithms may be combined with other algorithms, such as optimization algorithms. In one example, a linear regression algorithm is combined with a gradient descent optimization algorithm to process the received data and produce the connection quality data 214.

The computing device 202 groups the network experience data 210 per network 108 based on characteristics or properties described by the corresponding device context 212. For example, the computing device 202 groups the network experience data 210 for each network 108 based on device characteristics, network characteristics, and/or user characteristics. The computing device 202 may also normalize the network experience data 210 for each of the networks 108.

In some embodiments, the computing device 202 removes personally identifiable information from the received network experience data 210 and corresponding device context 212. For example, the computing device 202 sanitizes, cleanses, or otherwise anonymizes the crowdsourced data by removing user names, passwords, and the like.

At 306, the computing device 202 generates the connection quality data 214 for one or more of the networks 108 based on the processed network experience data 210 and corresponding device context 212. In some embodiments, the computing device 202 evaluates the processed data to determine if enough source data for a particular network 108 exists to generate connection quality data 214 for that network 108. For example, the computing device 202 may generate the connection quality data 214 for networks 108 for which a threshold amount of data has been received from the mobile computing devices 102.

Generating the connection quality data 214 includes, as an example, predicting future performance of one or more of the networks 108 based on the processed data crowdsourced from the mobile computing devices 102. In some embodiments, the computing device 202 calculates a quality score for one or more of the networks 108 to quantify and/or qualify the expected performance of each of the networks 108.

Further, the cloud service 104 may manipulate the connection quality data 214 to implement congestion control to shape network traffic to prevent overloading particular networks 108. For example, if the cloud service 104 produces connection quality data 214 indicating that a particular network 108 provides excellent quality, then too many mobile computing devices 102 may attempt to connect to the particular network 108, resulting in congestion for that network 108. As such, the cloud service 104 may manipulate the connection quality data 214 for the particular network 108 to disfavor that network 108 (e.g., lower a quality score), in anticipation of the quantity of mobile computing devices 102 that will connect to that particular network 108 and/or after receiving feedback from the mobile computing devices 102 that have connected to that network 108. For example, a quality score in the connection quality data 214 may be lowered enough to prevent the mobile computing devices 102 from connecting to the network 108.

The cloud service 104 may also manipulate or tune the connection quality data 214 to prefer secure networks 108. For example, the cloud service 104 may increase a quality score in the connection quality data 214 for those networks 108 with security (e.g., virtual private networks) and/or decrease the quality score for unsecured networks 108. In another example, the cloud service 104 may omit a quality score from the connection quality data 214 for those networks 108 lacking a minimum amount of network experience data 210 (e.g., the amount of network experience data 210 collected from the mobile computing devices 102 is below a pre-defined threshold). In this manner, the cloud service 104 indicates that these networks 108 may be rogue or malicious networks.

In some embodiments, the generated connection quality data 214 is used to update previously generated connection quality data 214 stored in the memory area 206. For example, the quality scores for a particular network 108 may be adjusted up or down depending on recent feedback in the network experience data 210 received from the mobile computing devices 102.

At 308, the computing device 202 distributes, or otherwise makes available, the generated connection quality data 214 to any of the mobile computing devices 102. For example, the computing device 202 may share the connection quality data 214 with the same mobile computing devices 102 that provided the network experience data 210 and corresponding device context 212. In another example, the computing device 202 crowdsources the network experience data 210 from each of a first set of mobile computing devices 102, and distributes the generated connection quality data 214 to a second set of mobile computing devices 102. Some of the mobile computing devices 102 may be in both the first set and the second set.

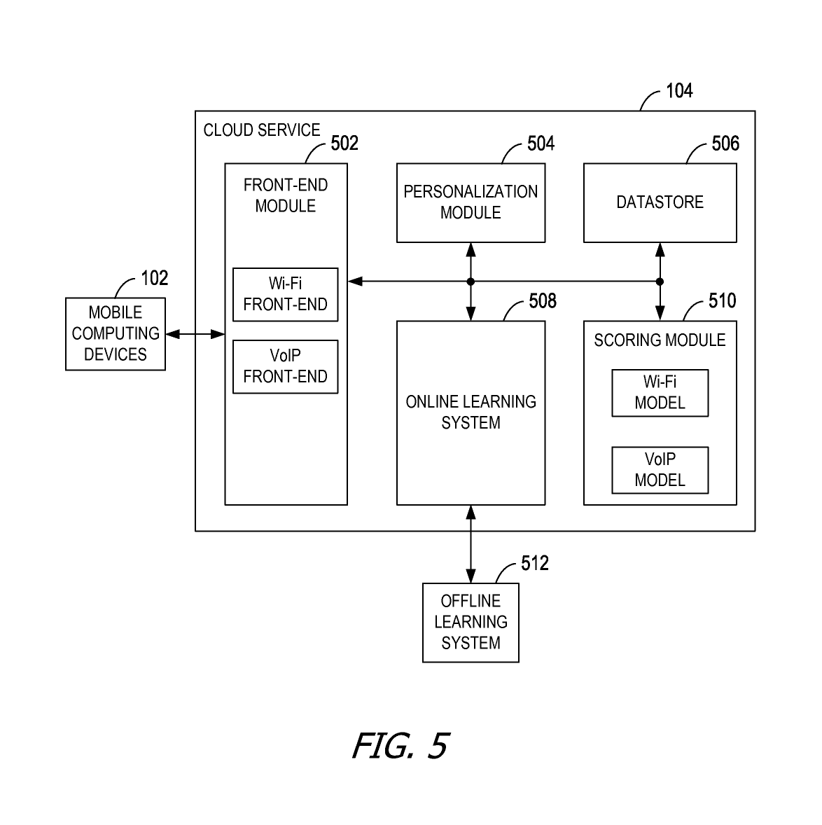

The computing device 202 may store the generated connection quality data 214 in a front-end cache (e.g., such as a front-end module 502 in FIG. 5) for access (e.g., on demand, such as in response to a request) by the mobile computing devices 102. Alternatively or in addition, the computing device 202 may push the generated connection quality data 214 to one or more of the mobile computing devices 102. For example, the computing device 202 (or another web service) may push the data, or a portion thereof, to those mobile computing devices 102 that have subscribed and/or registered to receive the generated connection quality data 214. The mobile computing devices 102 may subscribe and/or register, in some instances, to receive connection quality data 214 for a particular set of networks 108 (e.g., networks 108 within a particular geographic area).

In some embodiments, the computing device 202 distributes the generated connection quality data 214 in one or more data structures, such as geospatial tiles. Each tile stores the connection quality data 214 describing networks 108 within a particular geographic area (e.g., within one square mile). As an example, each tile stores information such as a service set identifier (SSID) and basic service set identifier (BSSID) of network access points, the locations of the network access points, and the connection quality data 214 of those network access points. The tiles may further store attributes of the connection quality data 214, such as a time of day, an expiration value, and/or a confidence level (e.g., an amount or quantity of data input to calculate the connection quality data 214). In some embodiments, the expiration value for the connection quality data 214 for a particular network 108 is based on the stability of that particular network 108. One or more of the tiles may be downloaded (e.g., once a day) by the mobile computing device 102 for caching.

Upon receiving the generated connection quality data 214, the mobile computing devices 102 identify and select networks 108 for connection.

Referring next to FIG. 4, an exemplary flow chart illustrates operation of the cloud service 104 to update connection quality data 214 based on network usage feedback received from the mobile computing devices 102. The operations illustrated in FIG. 4 are described with reference to execution by the computing device 202 associated with the cloud service 104. However, aspects of the disclosure contemplate execution of the operations by other devices or processors, such as by one or more of the mobile computing devices 102. Further, while some operations are described with reference to execution of the computer-executable components embodied or otherwise stored in the memory area 206, one or more of the operations may be performed by other components or modules of the cloud service 104.

The aggregation component 216, when executed by the processor 204, causes the processor 204 to process the network experience data 210 (e.g., first network experience data) and the corresponding device context 212, received from one or more of the mobile computing devices 102 (e.g., a first set), for one of the networks 108. The machine-learning component 218, when executed by the processor 204, causes the processor 204 to generate connection quality data 214 for the network 108 based on the data received by the aggregation component 216. The tile component 220, when executed by the processor 204, causes the processor 204 to distribute, to one or more of the mobile computing devices 102 (e.g., a second set), the connection quality data 214 generated by the machine-learning component 218. In some embodiments, the first set and the second set have one or more of the same members.

At 402, the feedback component 222, when executed by the processor 204, causes the processor 204 to determine whether additional network experience data 210 (e.g., second network experience data) has been received, from one or more of the mobile computing devices 102, relating to a network 108 for which previously generated connection quality data 214 exists. The additional network experience data 210 is considered network usage feedback, in some embodiments, from at least one of the mobile computing devices 102 that previously received the connection quality data 214 and observed performance of the network 108. For example, the mobile computing device 102 has selected one of the networks 108 for connection, established a connection, and reported the quality of connection (e.g., rated a VoIP call on a scale of one to five).

If additional network experience data 210 has been received, the feedback component 222 compares this network usage feedback with the previously generated connection quality data 214 at 404. For example, the cloud service 104 determines if the additional network experience data 210 (e.g., observation data) deviates from what was predicted, and evaluates why the deviation occurred.

At 406, the feedback component 222 re-trains, re-scores, or otherwise adjusts the previously generated connection quality data 214 based on the comparison. For example, the feedback component 222 may increase a score associated with the connection quality data 214 if the network usage feedback indicates a performance level above what had been previously received by the computing device 202. Conversely, the feedback component 222 may decrease a score associated with the connection quality data 214 if the network usage feedback indicates a performance level below what had been previously received by the computing device 202 (e.g., if congestion in the network 108 is indicated).

In some embodiments, the feedback component 222 throttles or otherwise tunes, based on the comparison at 404, an amount of the network experience data 210 and corresponding device context 212 to be received from the mobile computing devices 102. The amount of data collected may also be increased or decreased based on how much data is needed to improve the models that produce the connection quality data 214. For example, the feedback component 222 may have received enough network experience data 210 for the network 108 to have a high confidence value associated with the connection quality data 214. In another example, the network experience data 210 may indicate that the network 108 is stable, thus prompting the feedback component 222 to reduce the amount of network experience data 210 collected for that network 108. The feedback component 222 may implement throttling, in some embodiments, by sending a request or command to the mobile computing devices 102, publishing a notification available to the mobile computing devices 102, and the like. In this manner, the cloud service 104 is able to adjust and adapt, in real-time, the connection quality data 214.

Referring next to FIG. 5, an exemplary block diagram illustrates structure and organization of the cloud service 104. The structure and organization of the cloud service 104 shown in FIG. 5 are merely exemplary, and other structures, organizations, and configurations are within the scope of aspects of the disclosure.

In the example of FIG. 5, the cloud service 104 includes at least one front-end module 502, a personalization module 504, a datastore 506, an online learning system 508, and a scoring module 510. The mobile computing devices 102 communicate with one or more of the front-end modules 502 based on the capabilities and configurations of the mobile computing devices 102. Exemplary front-end modules 502 include, but are not limited to, web services such as a Wi-Fi front-end and a VoIP front-end. The mobile computing devices 102 executing Wi-Fi functionality communicate with the Wi-Fi front-end, while the mobile computing devices 102 executing VoIP functionality communicate with the VoIP front-end.

The front-end module 502 has logic for encoding, compressing, or otherwise serializing data for the mobile computing devices 102. The front-end module 502 also handles security and authentication as well as logging.

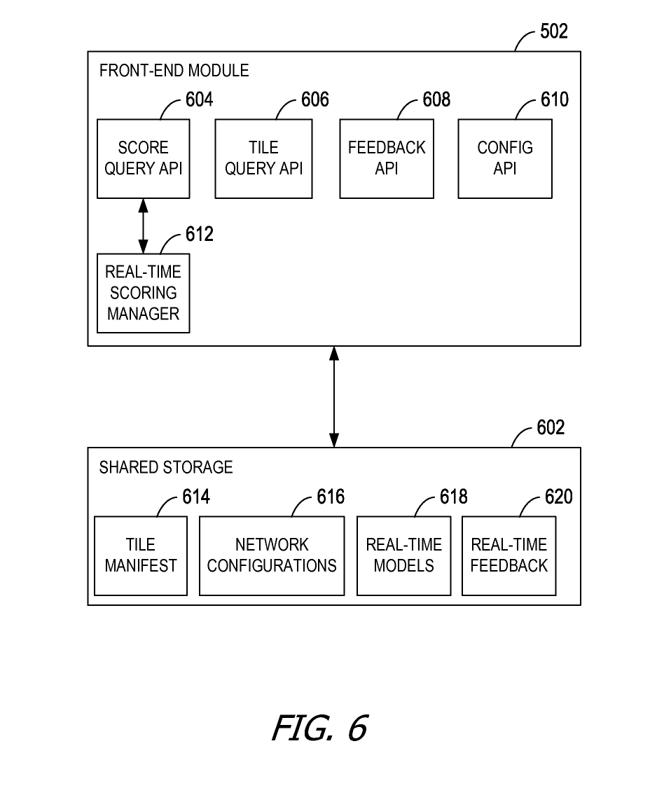

The front-end module 502 receives a query from the mobile computing device 102 for a ranked set of networks 108 within a vicinity of the mobile computing device 102. The front-end module 502 also receives the device context 212. The front-end module 502 communicates with the online learning system 508 to obtain the ranked set of networks 108. After providing the ranked set of networks 108 to the mobile computing device 102, the front-end module 502 may subsequently receive real-time feedback (e.g., real-time feedback 620 in FIG. 6) from the mobile computing device 102 about any networks 108 to which the mobile computing device 102 has connected, and relays the feedback to other components.

The datastore 506, or other storage area, stores collected data samples of the network experience data 210 and the corresponding device context 212. The data store is capable of being queried based on location, network identifier, user identifier, network type, and/or other properties.

The online learning system 508 operates to provide ordered sets of networks 108, and employs machine-learning techniques to provide results quickly. For example, the online learning system 508 operates to provide an ordered set of Wi-Fi networks for a given device context 212 (e.g., pivoting on the location of the mobile computing device 102 to obtain a list of networks 108 scored by the scoring module 510). In another example, the online learning system 508 operates to provide an ordered set of networks 108 according to VoIP quality scores given the device context 212.

The online learning system 508 may also pass the ordered sets of networks 108 to the personalization module 504 for re-ranking, in some embodiments. The personalization module 504 receives the ranked set of networks 108 and the device context 212 and re-ranks the set based on one or more rules. Exemplary rules include ranking free Wi-Fi networks first, followed by Wi-Fi networks to which the user has access, and then followed by cellular networks. Other rules may include ranking the user's home and work Wi-Fi networks first. Still other rules may boost the quality score for networks 108 with large dwell time for the user and networks 108 that the user has manually connected to in the past. Networks 108 to which the user has no access are removed from the set. The re-ranked set of networks 108 are returned by the personalization module 504 to the online learning system 508, which then provides the set to the front-end module 502 for distribution to the mobile computing device 102. The online learning system 508 also accepts feedback about network usage received from the mobile computing devices 102 and re-scores or re-ranks the set of networks 108 in real-time.

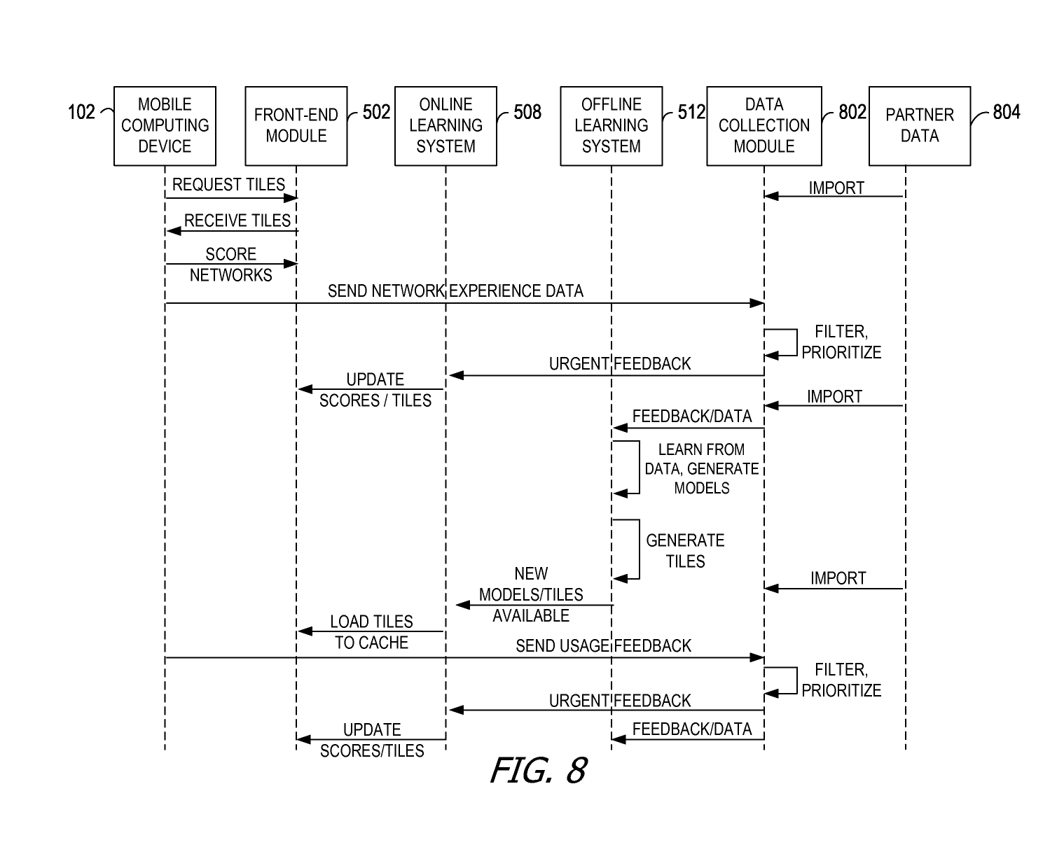

The online learning system 508 communicates with an offline learning system 512. The offline learning system 512 is discussed below with reference to FIG. 8.

The scoring module 510 operates to weight and configure the network experience data 210 to produce a set of models. Some embodiments contemplate a separate model based on the device context 212, such as for each network type, for each device, and/or for each geographic location (e.g., zip code, city, or any other defined map area). Exemplary scoring modules 510 include, but are not limited to, a Wi-Fi model and a VoIP model. The Wi-Fi model provides, for each of a plurality of the networks 108, a quality score for Wi-Fi data transmissions on the network 108 in a particular location at a particular date and time. The VoIP model provides, for each of a plurality of the networks 108, a quality score for VoIP call quality on the network 108 in a particular location at a particular date and time.

In general, the models describe a set of inputs to machine-learning algorithms and the weightings of each of the inputs. In operation, aspects of the disclosure operate to adjust the models, based on feedback over time, by adjusting the inputs and/or weightings.

In some embodiments, the scoring module 510 takes a network identifier or other values from the device context 212 as input and provides a quality score (or other connection quality data 214) for the network 108 corresponding to the network identifier. The quality score expresses the quality of data transmissions over the network 108.

Referring next to FIG. 6, an exemplary block diagram illustrates structure and organization of front-end modules 502 of the cloud service 104. The structure and organization of the front-end modules 502 shown in FIG. 6 are merely exemplary, and other structures, organizations, and configurations are within the scope of aspects of the disclosure.

The front-end module 502 illustrated in FIG. 6 includes a score query application programming interface (API) 604, a tile query API 606, a feedback API 608, a config API 610, and a real-time scoring manager 612. The score query API 604 communicates with the offline learning system 512 and real-time scoring manager 612 to provide a score for the requested networks. The tile query API 606 communicates with the tile store to provide geo-spatial tiles containing networks and their scores for requested locations. The feedback API 608 communicates with a real-time feedback module (e.g., real-time scoring manager 612) to adjust network scoring based on current observed network performance. The config API 610 provides device configuration data on service endpoints, which data to collect, and duration of tests. The real-time scoring manager 612 operates to provide real-time scoring information.

The front-end module 502 communicates with shared storage 602. The shared storage 602 stores a tile manifest 614, network configurations 616, real-time models 618, and real-time feedback 620. The tile manifest 614 represents a set of tiles. The network configurations 616 represent unique networks and their associated metadata such as frequency, authentication, and location. The real-time models 618 represent models obtained from the online learning system 508. The real-time feedback 620 represents feedback received from the mobile computing devices 102.

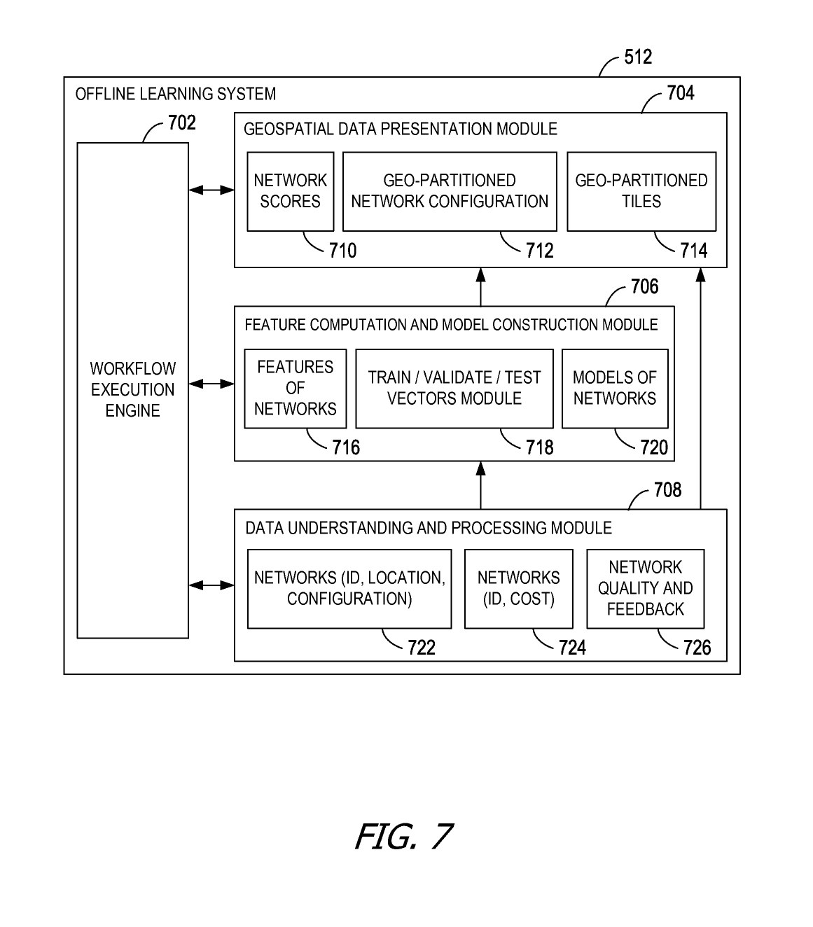

Referring next to FIG. 7, an exemplary block diagram illustrates structure and organization of the offline learning system 512 of the cloud service 104. The structure and organization of the cloud service 104 shown in FIG. 5 are merely exemplary, and other structures, organizations, and configurations are within the scope of aspects of the disclosure.

The offline learning system 512 illustrated in FIG. 7 includes a workflow execution engine 702 that manages a data understanding and processing module 708. The data understanding and processing module 708 produces data for a feature computation and model construction module 706. The feature computation and model construction module 706 produces data for a geospatial data presentation module 704.

The data understanding and processing module 708 operates to normalize networks 108 and associate them with network quality data. The module supports a function such as Networks(ID,Location,Configuration) 722 to look up network location and connection metadata (e.g., encryption, authentication, etc.). The module further supports a function such as Networks(ID,Cost) 724 to look up the network usage cost (e.g., cost per megabyte). The module further supports logic for processing network quality and feedback 726.

The feature computation and model construction module 706 operates to create machine-learning models for predicting future network quality. The module 706 stores features 716 of networks 108 and models 720 of networks 108, and supports a train/validate/test vectors module 718. The train/validate/test vector module operates to train machine-learning models for predicting future network quality on a data set, validating the accuracy of those models using a separate data set, and testing on a blind data set.

The geospatial presentation module 704 operates to divide networks 108 by location for delivery and caching. The module 704 stores network scores 710, geo-partitioned network configuration 712, and geo-partitioned tiles 714.

Referring next to FIG. 8, an exemplary sequence diagram illustrates interaction among the mobile computing devices 102 and modules of the cloud service 104. The interaction among the elements shown in FIG. 8 is merely exemplary, and other interactions and sequences are within the scope of aspects of the disclosure.

In the example of FIG. 8, the mobile computing device 102 requests one or more tiles from the front-end module 502. The mobile computing device 102 receives the requested tiles from the front-end module 502. The mobile computing device 102 scores the networks 108 represented by the tiles by evaluating performance of the networks 108, and provides the front-end module 502 with the scores. The mobile computing device 102 sends the network experience data 210 to a data collection module 802. The data collection module 802 filters, prioritizes, or otherwise processes the network experience data 210 as data input samples. The data collection module 802 sends urgent feedback, or any other notification of particular relevance or importance, to the online learning system 508. The online learning system 508 provides the front-end module 502 with updated tiles reflecting updated connection quality data 214. For example, the urgent feedback may result from a catastrophic loss of connectivity for a particular one of the networks 108, and the online learning system 508 pushes updated tiles to reflect the change in quality score the network 108.

The data collection module 802 further sends feedback and other data to the offline learning system 512. The offline learning system 512 generates models from the received feedback and data, which is then used to generate tiles. The models and tiles are made available to the online learning system 508. The online learning system 508 loads the tiles to a cache on the front-end module 502.

At some point in time, the mobile computing device 102 may send network usage feedback (e.g., additional network experience data 210) to the data collection module 802. The data collection module 802 integrates the received data by filtering, prioritizing, or otherwise processing the received data. The data collection module 802 sends urgent feedback, or any other notification of particular relevance or importance, to the online learning system 508. The online learning system 508 provides the front-end module 502 with updated tiles reflecting updated connection quality data 214. The data collection module 802 further sends feedback and other data to the offline learning system 512, which then generates updated models as described above.

At various times throughout the sequence illustrated in FIG. 8, the data collection module 802 imports partner data 804 (e.g., data obtained previously) which is combined with the network experience data 210 received from the mobile computing device 102 to provide feedback to the online learning system 508 and the offline learning system 512.

### Additional Examples

In an example scenario supported by aspects of the disclosure, the user is in a local café and places a call with the mobile computing device 102. As the user is placing the call, the mobile computing device 102 has already automatically and silently scanned for all the available networks 108 nearby, determined which networks 108 the mobile computing device 102 can obtain access to, has ranked the networks 108, and selected one of the networks 108 for connection. By the time the user hits the call button, the mobile computing device 102 has automatically connected to the café's free Wi-Fi hotspot. The user is excited to be able to make an affordable call with great audio quality.

In another example scenario supported by aspects of the disclosure, the user is consuming data on a cellular network by watching a movie. While watching the movie, the mobile computing device 102 determines that the user has exceeded the amount of data included with the data plan of the user. The mobile computing device 102 detects nearby networks 108, ranks the available Wi-Fi networks, selects a free Wi-Fi network, connects to the free Wi-Fi network, and transitions the current connection of the user from the cellular network to the Wi-Fi network, without interrupting the user or streaming of the movie.

In still another example scenario, the mobile computing device 102 becomes aware of various Wi-Fi hotspots and cellular networks and their characteristics throughout the day. Because the user has opted-in to the data collection program, details about the encountered networks 108 are collected and periodically uploaded to the cloud service 104. The user is not noticeably impacted by this activity.

In yet another example scenario, the user stops into a local coffee shop to meet a friend. The user checks for available Wi-Fi hotspots and sees that the coffee shop hotspot is rated as having excellent quality for voice and data. The user connects to the hotspot and uses a web browser and several social applications while waiting to meet a friend. While waiting, the mobile computing device 102 receives a VoIP call and a cellular call. While the mobile computing device 102 is in use, the mobile computing device 102 collects data on the network experience without disturbing the user or impacting the mobile computing device 102 noticeably. The collected data is submitted to the cloud and aggregated with data from other users to score the networks 108 and connections made over them for throughput, latency, and reliability. These scores are available for other mobile computing devices 102.

In another example scenario, an employee of a mobile operator works to improve the data experience of smartphone customers of the mobile operator. Knowing that cellular data capacity in a particular geographic area is limited and knowing that increasing capacity is expensive, the employee views a data usage map for the geographic area. The data usage map represents the anonymized, crowdsourced network experience data 210 for the geographic area, and indicates where smartphones are using cellular data relative to Wi-Fi data. The employees realizes that the mobile operator can add Wi-Fi hotspots in a few locations and reduce a need to build additional cellular towers.

In another example scenario, the user notices that the quality of a Wi-Fi hotspot is poor. The user chooses to stop auto-connecting to this particular Wi-Fi hotspot, and the mobile computing device 102 then will not auto-connect to that W-Fi hotspot for a defined amount of time (e.g., never again, not for 24 hours, etc.). The mobile computing device 102 communicates the user preference to the cloud service 104, which decrements the quality score for the Wi-Fi hotspot. In this manner, the feedback from the user helps other users.

At least a portion of the functionality of the various elements in the figures may be performed by other elements in any of the figures, or an entity (e.g., processor, web service, server, application program, computing device, etc.) not shown in the figures.

In some embodiments, the operations illustrated in the flowcharts may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The term “roaming” as used herein refers, in some embodiments, to connectivity provided outside a subscriber's home zone that may be subject to additional tariffs, fees, or constraints. Roaming service may or may not be provided by the same mobile operator. The term “tethered” as used herein refers, in some embodiments, to situations where one device acts as an access point for another device for network access. A tethered connection may occur over a wired connection or a wireless connection. The term “Wi-Fi” as used herein refers, in some embodiments, to a wireless local area network using high frequency radio signals for the transmission of data. The term “BLUETOOTH” as used herein refers, in some embodiments, to a wireless technology standard for exchanging data over short distances using short wavelength radio transmission. The term “cellular” as used herein refers, in some embodiments, to a wireless communication system using short-range radio stations that, when joined together, enable the transmission of data over a wide geographic area. The term “NFC” as used herein refers, in some embodiments, to a short-range high frequency wireless communication technology for the exchange of data over short distances.

While no personally identifiable information is tracked by aspects of the disclosure, embodiments have been described with reference to data monitored and/or collected from the users. In some embodiments, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. In some embodiments, computer storage media are implemented in hardware. Exemplary computer storage media include hard disks, flash drives, and other solid-state memory. In contrast, communication media embody computer readable instructions, data structures, program modules, or other data in a modulated data signal such as a carrier wave or other transport mechanism and include any information delivery media.

Although described in connection with an exemplary computing system environment, embodiments of the disclosure are capable of implementation with numerous other general purpose or special purpose computing system environments, configurations, or devices.

Examples of well-known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Embodiments of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for crowdsourcing data from mobile computing devices 102 to form connection quality data 214 for distribution. For example, one or more of the embodiments contemplate means for receiving, from each of a first set of mobile computing devices 102, the network experience data 210 and corresponding device context 212, storing the received network experience data 210 and corresponding device context 212, grouping the network experience data 210 based at least on the corresponding device context 212 and the plurality of networks 108, updating the stored connection quality data 214 for one or more of the plurality of networks 108 based on the grouped network experience data 210, and distributing the updated connection quality data 214 to a second set of mobile computing devices 102.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for crowdsourcing data from mobile computing devices to form connection quality data for distribution, said system comprising:
a memory area associated with a computing device, said memory area storing network experience data and corresponding device context, the network experience data describing voice over Internet Protocol (VoIP) calls placed over a plurality of networks, the memory area further storing connection quality data for the plurality of networks; and
a processor programmed to:
receive, from each of a first set of mobile computing devices, the network experience data and corresponding device context;
store the received network experience data and corresponding device context in the memory area;
group the network experience data based at least on the corresponding device context and the plurality of networks;
update the connection quality data stored in the memory area for one or more of the plurality of networks based on the grouped network experience data; and
distribute the updated connection quality data to a second set of mobile computing devices.

2. The system of claim 1, wherein the device context comprises at least one of a device make, a device model, a hardware description, an operating system build, or a list of installed applications.

3. The system of claim 1, wherein the network experience data comprises at least one of network throughput, signal quality, jitter, packet loss, device movement, device location, or user dwell time on the plurality of networks.

4. The system of claim 1, wherein the network experience data comprises at least one of a start time for a voice over Internet Protocol (VoIP) call, an end time for a VoIP call, or a duration of a VoIP call.

5. The system of claim 1, wherein the processor is programmed to receive the network experience data and corresponding device context from one of the mobile computing devices in the first set upon an event occurring on said one of the mobile computing devices.

6. The system of claim 5, wherein event comprises at least one of a user placing a VoIP call or a user ending a VoIP call.

7. A method comprising:
receiving, from each of a first set of mobile computing devices, network experience data and corresponding device context, the network experience data describing performance of at least one of a plurality of networks as observed by the mobile computing device;
processing the received network experience data and corresponding device context;
generating connection quality data for one or more of the plurality of networks based on the processed network experience data and corresponding device context; and
distributing the generated connection quality data to a second set of mobile computing devices.

8. The method of claim 7, wherein processing comprises normalizing the network experience data.

9. The method of claim 7, wherein the device context comprises values for a plurality of characteristics, and wherein processing comprises grouping the received network experience data based on the plurality of characteristics.

10. The method of claim 9, wherein grouping comprises grouping the received network experience data based on at least one of device characteristics, network characteristics, or user characteristics.

11. The method of claim 7, wherein generating the connection quality data comprises predicting future performance of one or more of the plurality of networks.

12. The method of claim 7, wherein generating the connection quality data comprises calculating a quality score for one or more of the plurality of networks.

13. The method of claim 7, wherein distributing the generated connection quality data comprises distributing the generated connection quality data in a geospatial tile data structure.

14. The method of claim 7, wherein distributing the generated connection quality data comprises distributing the generated connection quality data in response to a request for the generated connection quality data.

15. The method of claim 7, wherein processing comprises removing personally identifiable information from the received network experience data and corresponding device context.

16. The method of claim 7, wherein processing comprising applying machine-learning algorithms to the received network experience data and corresponding device context.

17. One or more computer storage media embodying computer-executable components, said components comprising:
an aggregation component that when executed causes at least one processor to process first network experience data and corresponding device context received from each of a first set of mobile computing devices, said first network experience data describing performance of a network as observed by the mobile computing devices;
a machine-learning component that when executed causes at least one processor to generate connection quality data for the network based on said first network experience data and corresponding device context processed by the aggregation component;
a tile component that when executed causes at least one processor to distribute, to a second set of mobile computing devices, the connection quality data generated by the machine-learning component; and
a feedback component that when executed causes at least one processor to:
receive, from one of the mobile computing devices from the second set of mobile computing devices, second network experience data describing performance of the network as observed by said one of the mobile computing devices,
compare the received second network experience data with the generated connection quality data, and
adjust the generated connection quality data based on the comparison.

18. The computer storage media of claim 17, wherein the feedback component further throttles, based on the comparison, an amount of the first network experience data and corresponding device context received from each of a first set of mobile computing devices.

19. The computer storage media of claim 17, wherein the second network experience data indicates congestion in the network, and wherein the feedback component further adjusts the connection quality data for the network based on the congestion.

20. The computer storage media of claim 17, wherein the machine-learning component generates the connection quality data to describe voice over Internet Protocol (VoIP) call quality.
